(19) United States
(12) Patent Application Publication
(10) Pub. No.: US 2003/0055722 A1
(43) Pub. Date: Mar. 20, 2003

(54) Method and apparatus for control of advertisements

(75) Inventors: George Charles Perreault, Campbell, CA (US); John Vincent Bellantoni, Redwood City, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(73) Assignee: JAGTEC, Inc., Campbell, CA

(21) Appl. No.: 09/957,235

(22) Filed: Sep. 19, 2001

(51) Int. Cl. G06F 17/60

(52) U.S. Cl. 705/14; 709/223

(57) ABSTRACT

A method and apparatus for the control of advertisements are disclosed. A user level controls the display of an advertisement.

### FIELD OF THE INVENTION

The present invention pertains to controlling communications. More particularly, the present invention relates to a method and apparatus for control of advertisements.

### BACKGROUND OF THE INVENTION

As advertisement based services and communications increase, the need for controlling the advertisements increases. The ability to target and/or control advertisements is beneficial. Targeting advertisements is intended to increase the effectiveness of advertisements by yielding a higher response rate and/or response per unit cost. Control of advertisements may be beneficial by allowing a target to select those advertisements of interest.

### BRIEF DESCRIPTION OF THE DRAWINGS

The present invention is illustrated by way of example and not limitation in the figures of the accompanying drawings, in which like references indicate similar elements and in which:

FIG. 1 illustrates a network environment;

FIG. 2 is a block diagram of a computer system;

FIG. 3 illustrates in block diagram form one embodiment of the present invention;

FIG. 4 illustrates another embodiment of the present invention;

FIGS. 5A through 5G illustrate embodiments of video muting;

FIGS. 6 and 7 illustrate alternative embodiments of the present invention;

FIG. 8 illustrates one embodiment of a user preference screen;

FIG. 9 illustrates one embodiment of how a user request may be processed;

FIG. 10 illustrates one embodiment of operating on a media stream;

FIG. 11 illustrates one embodiment of a user control database screen; and

FIG. 12 illustrates one embodiment of storing and accessing control code information from a database.

### DETAILED DESCRIPTION

A method and apparatus for control of advertisements are described.

For purposes of discussing the invention, it is to be understood that various terms are used by those knowledgeable in the art to describe techniques and approaches.

In the following description, for purposes of explanation, numerous specific details are set forth in order to provide a thorough understanding of the present invention. It will be evident, however, to one skilled in the art that the present invention may be practiced without these specific details. In some instances, well-known structures and devices are shown in block diagram form, rather than in detail, in order to avoid obscuring the present invention. These embodiments are described in sufficient detail to enable those skilled in the art to practice the invention, and it is to be understood that other embodiments may be utilized and that logical, mechanical, electrical, and other changes may be made without departing from the scope of the present invention.

Some portions of the detailed descriptions that follow may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of acts leading to a desired result. The acts are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The present invention can be implemented by an apparatus for performing the operations herein. This apparatus may be specially constructed for the required purposes, or it may comprise a general-purpose computer, selectively activated or reconfigured by a computer program stored in the computer. Such a computer program may be stored in a computer readable storage medium, such as, but not limited to, any type of disk including floppy disks, hard disks, optical disks, compact disk-read only memories (CD-ROMs), and magnetic-optical disks, read-only memories (ROMs), random access memories (RAMs), electrically programmable read-only memories (EPROM)s, electrically erasable programmable read-only memories (EEPROMs), FLASH memories, magnetic or optical cards, etc., or any type of media suitable for storing electronic instructions either local to the computer or remote to the computer.

The algorithms and displays presented herein are not inherently related to any particular computer or other apparatus. Various general purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor, or by any combination of hardware and software. One of skill in the art will immediately appreciate that the invention can be practiced with computer system configurations other than those described below, including hand-held devices, multiprocessor systems, microprocessor-based or programmable consumer electronics, digital signal processing (DSP) devices, network PCs, minicomputers, mainframe computers, and the like. The invention can also be practiced in distributed computing environments where tasks are performed by remote processing devices that are linked through a communications network. The required structure for a variety of these systems will appear from the description below.

The methods of the invention may be implemented using computer software. If written in a programming language conforming to a recognized standard, sequences of instructions designed to implement the methods can be compiled for execution on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, application, driver, . . . ), as taking an action or causing a result. Such expressions are merely a shorthand way of saying that execution of the software by a computer causes the processor of the computer to perform an action or produce a result.

It is to be understood that various terms and techniques are used by those knowledgeable in the art to describe communications, protocols, applications, implementations, mechanisms, etc. One such technique is the description of an implementation of a technique in terms of an algorithm or mathematical expression. That is, while the technique may be, for example, implemented as executing code on a computer, the expression of that technique may be more aptly and succinctly conveyed and communicated as a formula, algorithm, or mathematical expression. Thus, one skilled in the art would recognize a block denoting A+B=C as an additive function whose implementation in hardware and/or software would take two inputs (A and B) and produce a summation output (C). Thus, the use of formula, algorithm, or mathematical expression as descriptions is to be understood as having a physical embodiment in at least hardware and/or software (such as a computer system in which the techniques of the present invention may be practiced as well as implemented as an embodiment).

A machine-readable medium is understood to include any mechanism for storing or transmitting information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.); etc.

It is understood by those knowledgeable in the art, that the transfer of information may be used to effect a transfer of an offer's contents, money, credits, etc. In this respect the depository for the information may represent an account or fund, for example, a user's checking account, an educational fund, a trust fund, etc. What is to be appreciated is that the information represents a tangible asset. As used in this application an account, a fund, a repository, etc. are to be understood as the same as far as holding information representing tangible assets and/or actual tangible assets.

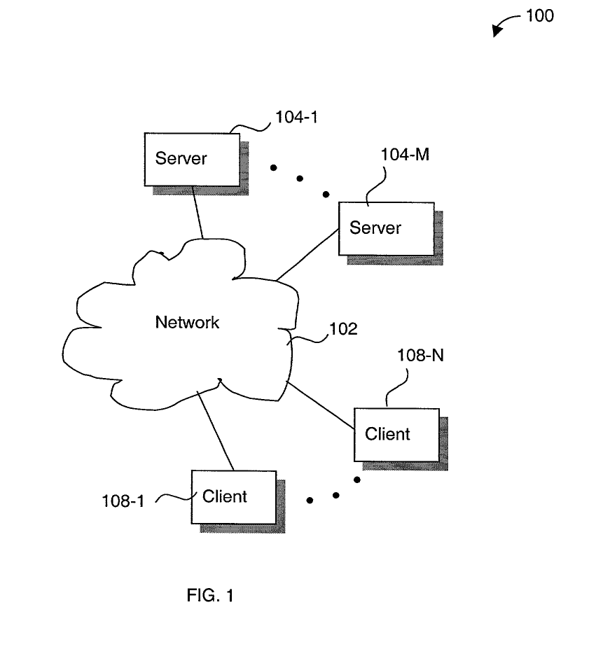

FIG. 1 illustrates a network environment 100 in which the techniques described may be applied. As shown, several computer systems in the form of M servers 104-1 through 104-M and N clients 108-1 through 108-N are connected to each other via a network 102, which may be, for example, the Internet. Note that alternatively the network 102 might be or include one or more of: a Local Area Network (LAN), Wide Area Network (WAN), satellite link, fiber network, cable network, or a combination of these and/or others. The method and apparatus described herein may be applied to essentially any type of communicating means or device whether local or remote, such as a LAN, a WAN, a system bus, a disk drive, storage, etc.

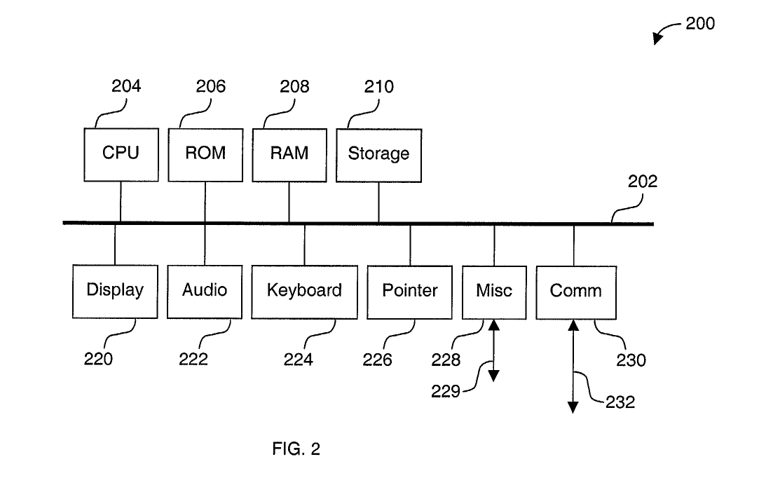

FIG. 2 illustrates a computer system 200 in block diagram form, which may be representative of any of the clients and servers shown in FIG. 1. The block diagram is a high level conceptual representation and may be implemented in a variety of ways and by various architectures. Bus system 202 interconnects a Central Processing Unit (CPU) 204, Read Only Memory (ROM) 206, Random Access Memory (RAM) 208, storage 210, display 220, audio, 222, keyboard 224, pointer 226, miscellaneous input/output (I/O) devices 228, and communications 230. The bus system 202 may be for example, one or more of such buses as a system bus, Peripheral Component Interconnect (PCI), Advanced Graphics Port (AGP), Small Computer System Interface (SCSI), Institute of Electrical and Electronics Engineers (IEEE) standard number 1394 (FireWire), etc. The CPU 204 may be a single, multiple, or even a distributed computing resource. The ROM 206 may be any type of non-volatile memory, which may be programmable such as, mask programmable, flash, etc. RAM 208 may be, for example, static, dynamic, synchronous, asynchronous, or any combination. Storage 210, may be Compact Disc (CD), Digital Versatile Disk (DVD), hard disks (HD), optical disks, tape, flash, memory sticks, video recorders, etc. Display 220 might be, for example, a Cathode Ray Tube (CRT), Liquid Crystal Display (LCD), a projection system, Television (TV), etc. Audio 222 may be a monophonic, stereo, three dimensional sound card, etc. The keyboard 224 may be a keyboard, a musical keyboard, a keypad, a series of switches, etc. The pointer 226, may be, for example, a mouse, a touchpad, a trackball, joystick, etc. I/O devices 228, might be a voice command input device, a thumbprint input device, a smart card slot, a Personal Computer Card (PC Card) interface, virtual reality accessories, etc., which may optionally connect via an input/output port 229 to other devices or systems. An example of a miscellaneous I/O device 228 would be a Musical Instrument Digital Interface (MIDI) card with the I/O port 229 connecting to the musical instrument(s). Communications device 230 might be, for example, an Ethernet adapter for local area network (LAN) connections, a satellite connection, a settop box adapter, a Digital Subscriber Line (xDSL) adapter, a wireless modem, a conventional telephone modem, a direct telephone connection, a Hybrid-Fiber Coax (HFC) connection, cable modem, etc. The external connection port 232 may provide for any interconnection, as needed, between a remote device and the bus system 202 through the communications device 230. For example, the communications device 230 might be an Ethernet adapter, which is connected via the connection port 232 to, for example, an external DSL modem. Note that depending upon the actual implementation of a computer system, the computer system may include some, all, more, or a rearrangement of components in the block diagram. For example, a thin client might consist of a wireless hand held device that lacks, for example, a traditional keyboard. Thus, many variations on the system of FIG. 2 are possible.

A subsystem may be, but is not limited to, one or more of the elements of FIG. 2. For example, Storage 210 may have a subsystem that handles how data is to be stored and retrieved. Audio 222 may have a subsystem that handles when to, for example, power down speakers or mute sound. Communications device 230 may, for example, have a subsystem that transfers information to the Storage 210 without using a main operating system. Additionally, the subsystem exemplified by the CPU 204 may have a separate bus to other subsystems, for example, memory. One such example may be for graphics, such as the AGP. Another may be a video port interface.

A presentation device, may be, but is not limited to audio and/or visual or video presentations. For example, an audio only presentation device, may be, for example, a radio, a stereo, a CD player, etc. A visual only presentation may be, for example, a computer screen (without speakers), a light display, the screen of a personal digital assistant, a wireless telephone display, a display on a pager, a movie screen, etc. A visual and audio presentation may be a video device such as a television, a projector, a movie theater, etc. A computer having a visual display and audio output through speakers is another example of a presentation device. It is to be understood that audiovisual is concerned with audible and visual signals. These signals are called by a variety of names, such as, sight, visual, video, sound, audible, etc. Thus, an audiovisual signal has audio sound signals and visual images. The actual signals used for the transmission may emanate from a variety of sources, however, for purposes of explanation in this instrument a visual signal is considered to come from a video source. While the terminology may vary, it is to be understood that audio signals and video signals eventually are presented to a user as an audible sound and a visual image.

Likewise, when discussing media, program, programs, program material, etc. is understood to be what is generally perceived as the media presentation that is desired to be watched versus advertisements, commercials, etc. which is to be understood as an “interruption” of the main media event and/or presentation. However, the distinction being delineated here is not advertisement versus program so much as a change in the presentation during a time period. For example, an infomercial, which is considered a “program” commercial or advertisement, may be interrupted by other shorter segments considered commercials or advertisements in their own right. What is to be appreciated is that the present invention views these segments as just that, segments, and thus can perform operations on them. For the convenience of this description, program is used to denote the main media presentation and advertisement is used to denote a generally shorter different segment. For purposes of this description: advertisement, ad, and commercial are considered to describe the same type of segment.

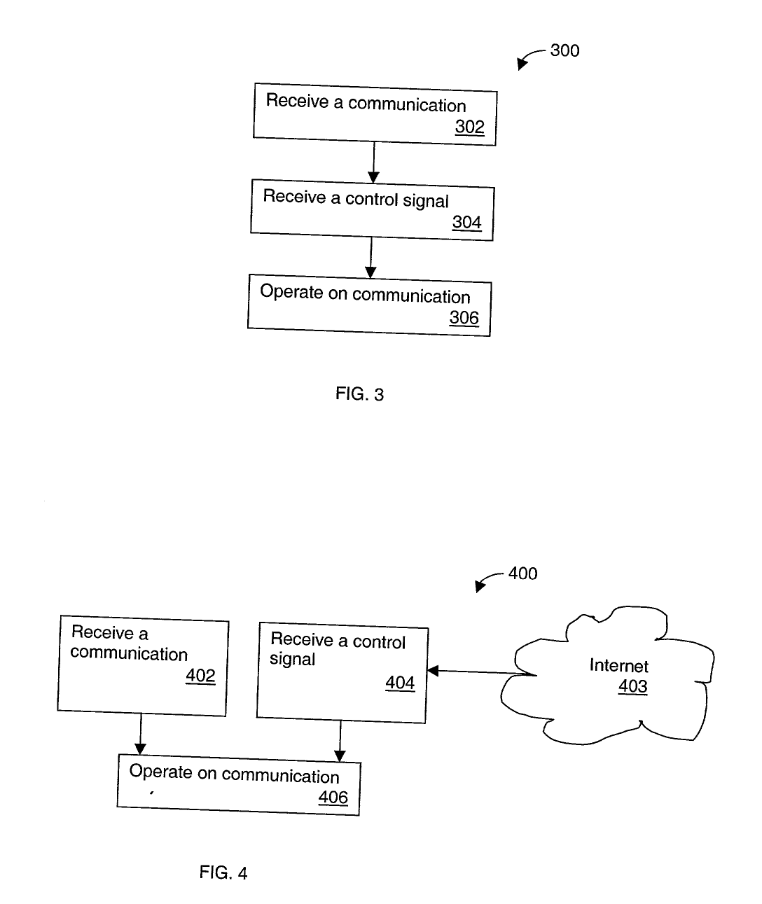

FIG. 3 illustrates in block diagram form one embodiment of the present invention 300. In this embodiment, a communication is received 302, a control signal is received 304, and then the communication is operated on 306. For example, the communication received 302 might be, but is not limited to, a video signal from a source such as a television (TV) tuner, a video cassette payback and/or recorder unit (VCR), a digital versatile disk (DVD) player, a high definition TV (HDTV) tuner, a cable box, a set-top box, etc. Such a video signal source may contain various segments of media, for example, program guides, program material, advertisements, etc. The control signal received 304, may be received from a variety of sources, such as, but not limited to, the communication received at 302, an Internet communication, a wireless link, the user and/or viewer, a telephone connection, a cable connection, a device with an audio or video output, a database, a computer, etc. The operation on the communication at 306, may be, but is not limited to, for example, muting the audio and/or video signal, changing the sound level, changing the contrast, brightness, and/or colors of a video signal, blocking part of the audio and/or video signal, inserting another audio and/or video source, etc.

For example, the received communication 302 may be a television broadcast containing a program and commercials. The control signal received 304, might be derived from the TV broadcast by a device that can discern when the material is a program versus a commercial. The operation on the communication 306, might be an audio and/or video muting of the commercial.

The control signal received 304, might be from other sources, for example, an example of a user and/or viewer communication may be, a real-time user initiated command coming from a hand-held remote control device.

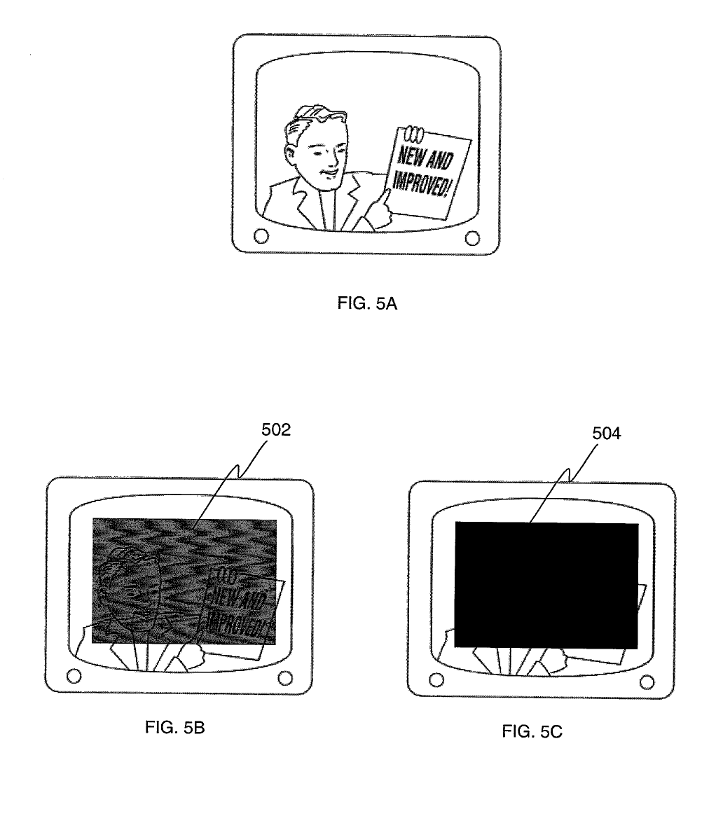

FIG. 4 illustrates another embodiment 400 of the present invention. In this illustration, a communication is received 402, a control signal is received 404 from an Internet 403 connection, and the communication is operated on 406. In this illustration, the control signal from the Internet may allow more capability for operating on the communication at 406.

For example, in a television broadcast of say a baseball game, the user may have set up an option where, the user wishes, during the regular commercial break to view the statistics of the top hitters in the game rather than the regular commercial. Thus, the control signal would direct that the operation on the communication 406 be the insertion of an alternative audio/video feed during the commercial period. Alternatively, other programming might be inserted, such as commercials orientated more toward the viewer's preference. Thus, for example, a viewer that does not own pets may be presented with an alternative ad in place of a pet ad. Additionally, the viewer may be willing to pay for this alternative feed. Likewise, an advertiser and/or sponsor may be willing to pay for a more targeted audience. In another example, the user may subscribe to an Internet based service that sends a control signal for simply muting all commercials from a program. Such a service as well as the ones described above may operate in real time and/or may be controlling a device such as a VCR for later playback. Thus, the baseball fan above, could view a delayed broadcast and still have the statistics that were recorded during the commercial period.

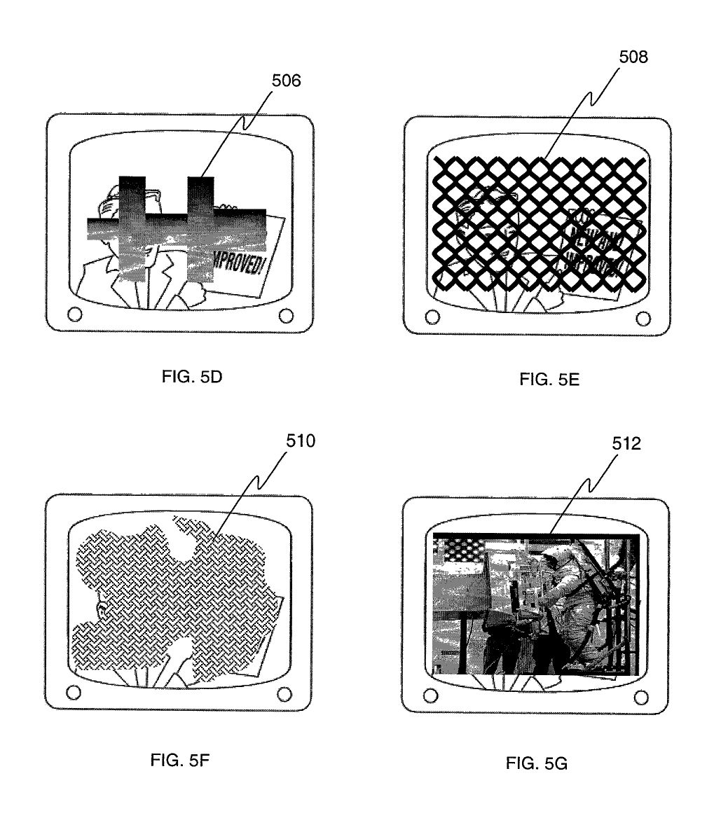

FIGS. 5A, 5B, and 5C illustrate embodiments of degrees of video muting. FIG. 5A represents a communication, in this case a commercial, which has not been operated on, i.e. no video muting. FIG. 5B illustrates a block 502 which has partially obstructed a portion of the commercial. FIG. 5C illustrates a block 504 which has completely obstructed the commercial in the area of the block 504. Other embodiments, as mentioned above, may alter other aspects of the video signal to yield different coloring, blocking all of the video, and/or inserting another video source, etc. For example, any arbitrary pattern and/or shape may be used to perform the muting. FIG. 5D illustrates a bar-type pattern 506, FIG. 5E illustrates a chain-link fence type pattern 508, and FIG. 5F illustrates an arbitrary pattern 510. Any pattern may have a varying or fixed degree of video muting as illustrated by the increasing opacity as illustrated in FIG. 5B and 5C. Additionally, as mentioned above, another video source may be presented and/or inserted to effect a video muting function of the original video source. One such embodiment is illustrated in FIG. 5G where another video signal 512 is presented over the original video.

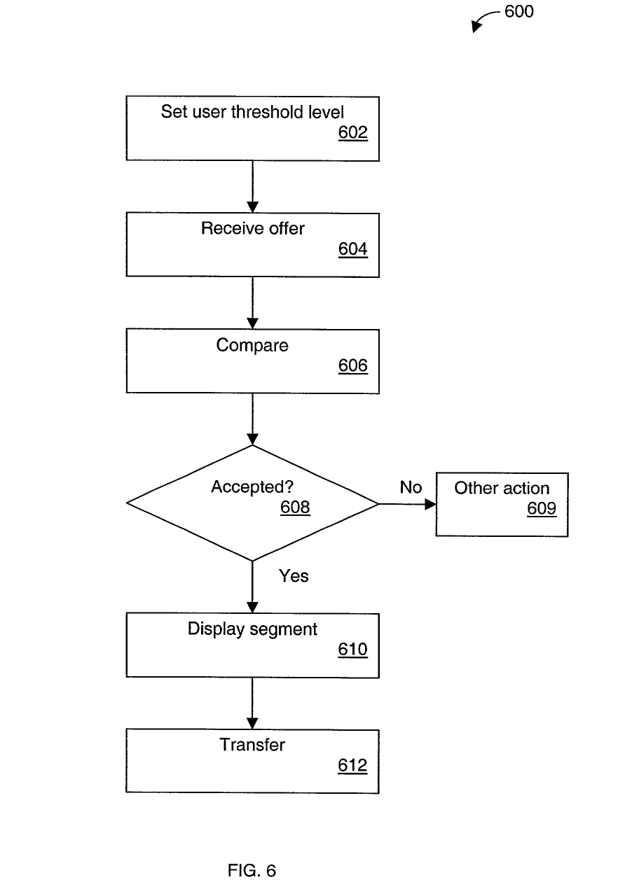

FIG. 6 illustrates another embodiment 600 of the present invention. In this embodiment, a user threshold level is set at 602. At 604 an offer is received and compared at 606. At 608 if the offer is not accepted then other action 609 is taken. If at 608 the offer is accepted then the segment is displayed 610 and a transfer 612 is performed.

For example, the user may have set a threshold 602 of $0.25 to view an advertisement. An advertiser may have sent an offer that was received at 604 of only $0.10 to view their ad. There is a comparison at 606 and if the comparison is based upon meeting the user threshold level, then in this example, the offer is not accepted and an alternative action (other action 609) may be taken. An alternative, action may be, but is not limited to, for example, video and/or audio muting the advertisement.

However, had the advertiser offered, for example $0.26 for the viewer to view the ad, then the comparison at 606, if based upon meeting the user threshold level, would be accepted 608 and the ad segment would be displayed 610 for user viewing and then a transfer 612 of the compensation would be effected. In an alternative embodiment and/or per a user option, the transfer may occur before the display of the advertisement. Additionally, different thresholds may be set based upon such things as time of day, type of advertisement, main program being viewed, main program rating (parental guidance (PG), etc.), viewers age, viewers income, etc. Thus, for example, a user may decide to block via audio and/or video muting, advertisements for feminine hygiene products for a young viewer, advertisements for food for a viewer on a diet, etc. The user may allow advertisements if the main program is rated, for example, PG or G. Yet in another example, a viewer may wish to view advertisements, one example is a sports fan may set a low or zero threshold to view sports equipment ads during a sporting event.

In alternative embodiments, the entity making the offer may be someone other than an advertiser. For example, a non-advertiser may be a coalition and/or industry group promoting and/or funding advertisements for products, such as for oranges, apples, nuts, cheese, etc. A subscriber may wish to pay for advertisements for themselves or other persons or subscribers. For example, a subscriber with say a heart condition, may be willing to pay to see ads directed to heart medications. A non-subscriber may make an offer, as well as a sponsor, a user of the system, a non-user, or even a third party, etc. For example, a third party, such as an Internet Service Provider (ISP) may make an offer to pay for advertisements for a game which is played through the ISP's resources. A sponsor may advertise on their own as well as sponsor other's advertisements, such as a telephone company sponsoring another company's ads for wireless phones.

The compensation may be in a variety of forms. For example, the compensation may be, but is not limited to, a credit, a discount, a free item, a voucher, a coupon, money, a certificate, a redemption certificate, a free play, a free view, an award, points, etc. For example, viewing a number of jean ads may entitle the viewer to a 10% discount coupon for jeans. In a similar manner, watching ads for a game may give a credit to a viewer for playing the game or result in a free play. Viewing ads for a movie may allow a free view of, for example, another program. Money, credits, etc. may be compensation for viewing ads.

The compensation may be deposited into a variety of different accounts based upon a user's and/or viewer's preference(s). Such accounts may be, but are not limited to, a credit card account, a checking account, a savings account, a payment account, a billing account, an escrow account, a debt account, a debit account, an incentive account, a credit account, a tax account, a trust account, a charity account, an education account, a child support account, an automatic payment account, a premium services account, and a third party account. For example, a user may have set a preference to transfer all compensation to his own bank account, that of another person, or perhaps a educational account set up by a school in need of supplies, money, etc. In another example, a user may have set preferences that direct that any credit card ad compensation obtained from viewing be used to reduce their own credit card balance.

Thus, in one embodiment, for example, a user may pay to have advertisements cut during viewing. In another embodiment a user's payment for the cutting of such ads may be sponsored by the user actually watching another advertiser's ads. Thus, a business model of the highest paying sponsor preempting the viewer's other advertisements and capturing the viewer's viewing time is possible.

Display of the segment 610 may be different in other embodiments. For example, in a radio-type embodiment, displaying the segment may be un-muting the audio so that a user may listen to, for example, an advertisement. In a television-type embodiment, displaying would enable viewing of a visual image and/or listening to the audio sound.

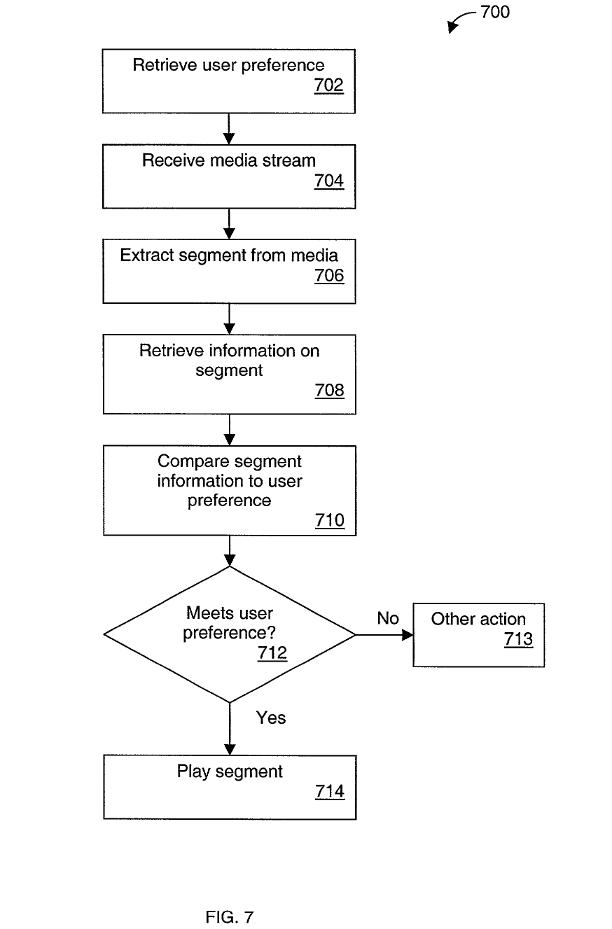

FIG. 7 illustrates another embodiment 700 of the present invention. In this embodiment a user preference is retrieved 702, a media stream is received 704, then a segment is extracted from the media 706, information on the segment is retrieved 708, a comparison of the segment information and a user preference is made 710, a check is made to see if the comparison meets the user preference 712. Then if the user preference is not met, other action 713 is taken. If the user preference is met then the segment is played 714.

Retrieving a user preference 702 and/or retrieving information on a segment 708 may be from a local and/or remote database. For example, the user may have set preferences in a local device such as device connected to a television with the preference to mute the sound during commercials. Alternatively, if the device is connected to a network, for example, the Internet, a set of predefined user preferences may by retrieved from a remote database. For example, during the day, when a parent is not a home, the parent may set preferences as to the programs that may be watched. Attempting to watch other programs may result in video muting. At other times, for example, after 10PM, when the parent is home, the preferences may be different. Preferences based on the program being viewed are also possible.

Information retrieved on the segment 708 may also affect user preferences. For example, if the program being watched is a child's program or rated for general audiences then user preferences which may have been predefined for such programs may be used. Also possible are predefined preferences from a third source that the user may adopt for use while retaining the option to customize preferences. Thus, a program producer may predefine a set of options based on the program material which may be used by the user. Additionally, third parties may set their own preferences for use by others. For example, a group opposed to alcoholic beverages may set preferences that would mute segments showing alcohol consumption or alcoholic beverage advertisements.

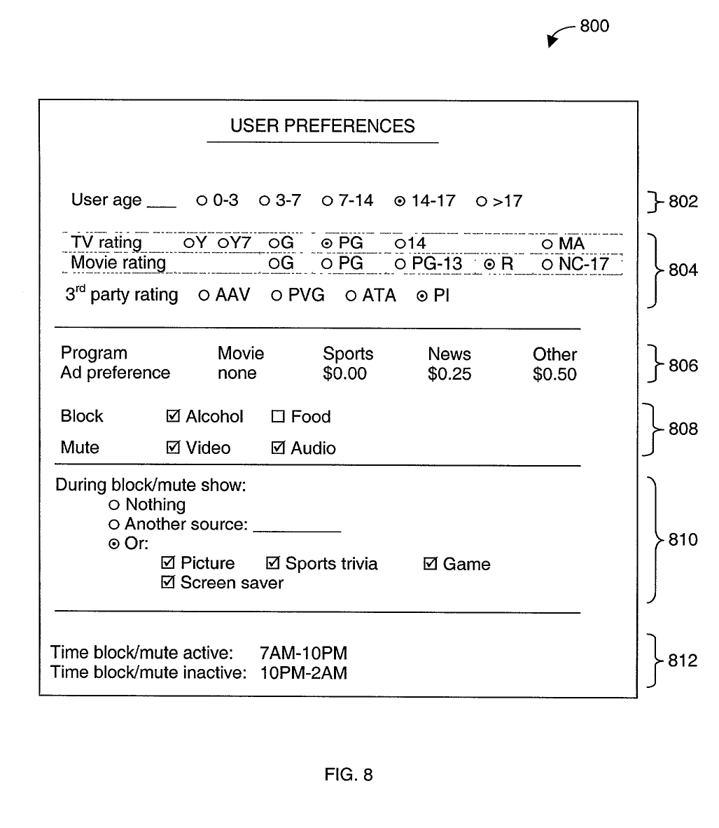

FIG. 8 illustrates one embodiment of a user preference screen 800 that may be accessible by the user on a computer and/or television screen. Here, the user may set preferences based on the user's age 802, ratings on the content of the program 804, ad preferences for each in the form of acceptable compensation 806, general material to block and how to mute 808. Additionally, there may be preferences related to what to do during a block 810, and time preferences for user activation 812.

In the specific screen 800 shown in FIG. 8, the user has selected the 14-17 age bracket, has selected to allow up to PG on a TV rating, up to an R Movie rating and has selected a 3^{rd} party rating by a group called PI. 3^{rd} party ratings may be those issued by independent organizations that review and rate programming based on their own criteria. For example, a group called Public Interest (PI) may issue ratings for programs. At 806 the user has specified 4 types of programs and the Ad preferences for each. In this example, Movie has none as the ad preference. Sports has $0.00, News $0.25, and Other has $0.50. So for example, if the program is News, the Ad preference of $0.25 might signify the amount the user is willing to accept to view a segment, such as an advertisement during the News program. Another user preference screen might allow the user to specify how payments are to be made and/or transferred. At 808 the user has asked that segments, such as advertisements and/or programs having alcohol be blocked. Additionally, at 808 the user has specified that Mute is to be both video and audio. At 810 the user has specified that during a block/mute that pictures, sports trivia, a game and/or a screen saver may be viewed. Lastly, in this example, the user has specified at 812 that the block/mute specified above be active from 7AM to 10PM and inactive from 10PM to 2AM.

Additionally, it is to appreciated that multiple user profiles may be set up, containing preferences, for example, for children, teenagers, adults, or even for individual people. In that way, users may have more control over their own preferences.

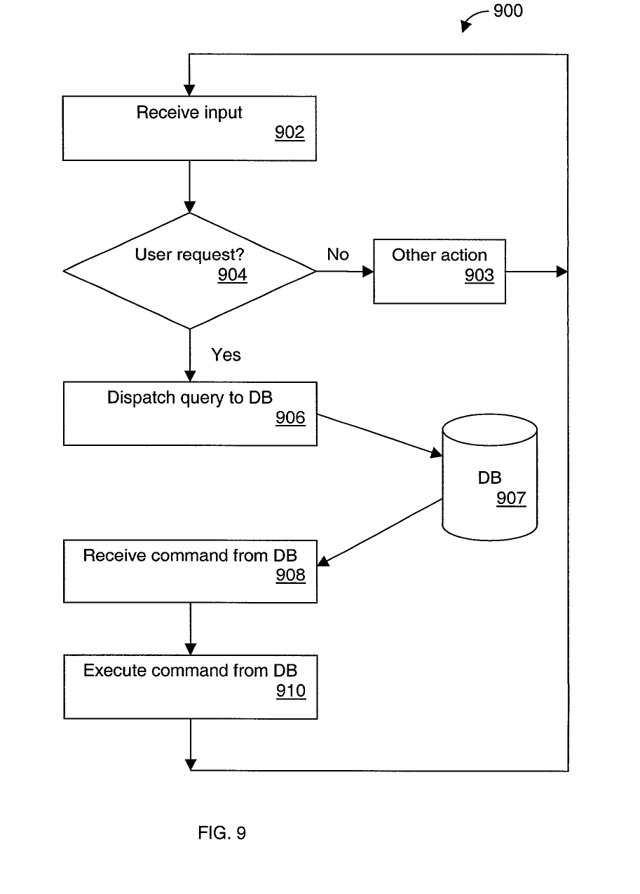

FIG. 9 illustrates one embodiment 900 of how a user request may be processed. At 902 input is received, at 904 a check is made of the received input 902 to determine if it is a user request. If the received input 902 is not a user request, then other action 903 may be taken and then back to 902 to receive input. If it is determined that the received input is a user request, then at 906 a dispatch query is made to a database (DB) based upon the user request. Database 907 transmits a response and at 908 a command is received from the database. At 910 the command from the database is executed, then back to 902 to receive input.

For example, a user may originate from a hand-held remote a request to block all commercials for the next two hours because they are watching a very interesting show. This request will send a query to the database with this request. The database may have a list of times for advertisement during the program being viewed. The database may send this information to be received or the database may send information on commands to execute during the appropriate time, for example, to mute the advertisements as they are presented during the next two hours. Thus, the commands received from the database may control a device and may implement the user requests.

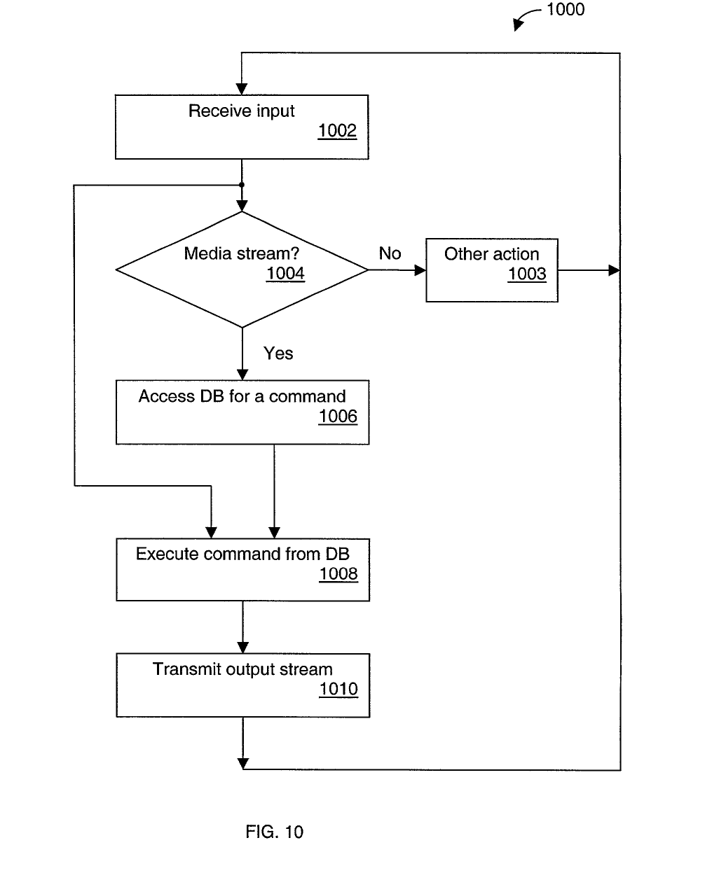

FIG. 10 illustrates one embodiment 1000 of operating on a media stream. Here at 1002 an input is received. At 1004 the input received at 1002 is check to determine if it is a media stream. If the input received at 1002 is not a media stream, then other action 1003 may be taken and then back to 1002 to receive input. If the input received at 1002 is determined at 1004 to be a media stream, then at 1006 access is made to a database for a command. At 1008 the command from the database is executed on the input received at 1002 which has been determined to be a media stream. After the command from the database is executed, then the output stream is transmitted at 1010 and then back to 1002 to receive input.

For example, the input received at 1002 may in one embodiment consist of scan lines of video representing a media stream. The command from a database may be to dim the contrast of the signal and the dimming may occur as a result of executing the command. The output may then be transmitted to, for example, a television display unit.

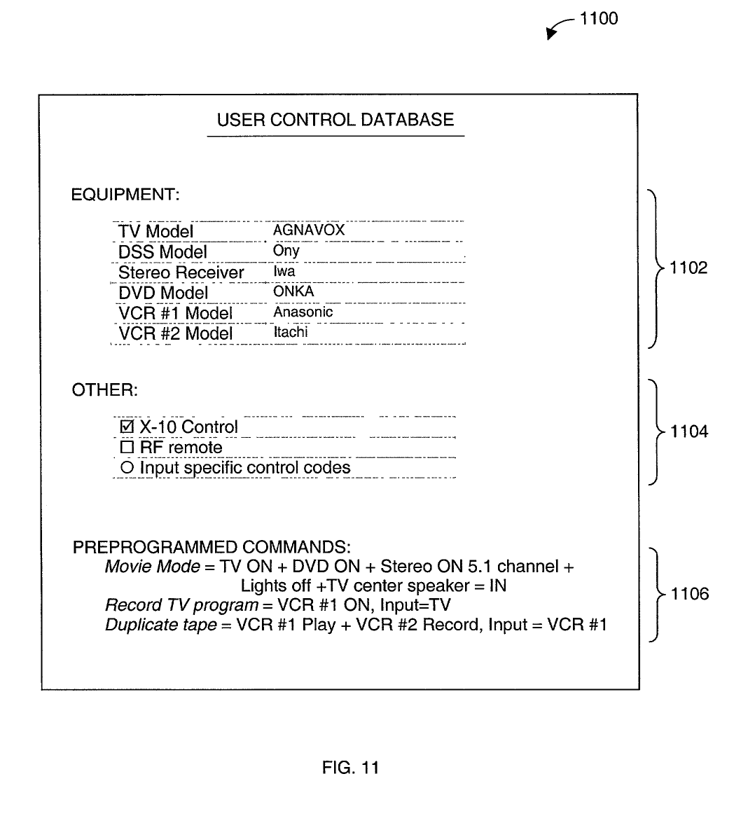

FIG. 11 illustrates one embodiment of a user control database screen 1100 where a user may input information on equipment they own, etc. At 1102 the user has a list of equipment, at 1104 Other control is defined, and at 1106 are preprogrammed commands. For example, at 1102 the user has defined that in this setup there are two VCRs. At 1104 the user has indicated that there is an X-10 control. At 1106 one of the preprogrammed commands is movie mode which has as one of the parameters that the lights be off. This functionality may be achieved, for example, by an X-10 controller. Based upon the information on this screen and/or the user inputting specific control codes (at 1104 for example) and/or looking up control codes in a database, a wide range of control and automated sequences may be achieved. For example, a database may be able to retrieve remote control codes associated with equipment indicated by the user. For example, if the user has supplied this information, a control unit may make use of these control codes to control the equipment. Also in the event that the user loses a remote control, the device may be instructed to control the device and/or download control codes to, for example, a learning universal remote.

In another embodiment, multiple user control databases may be set up. For example, one database may have information on equipment downstairs while another user database may have information on an audio/video setup in, for example, a bedroom.

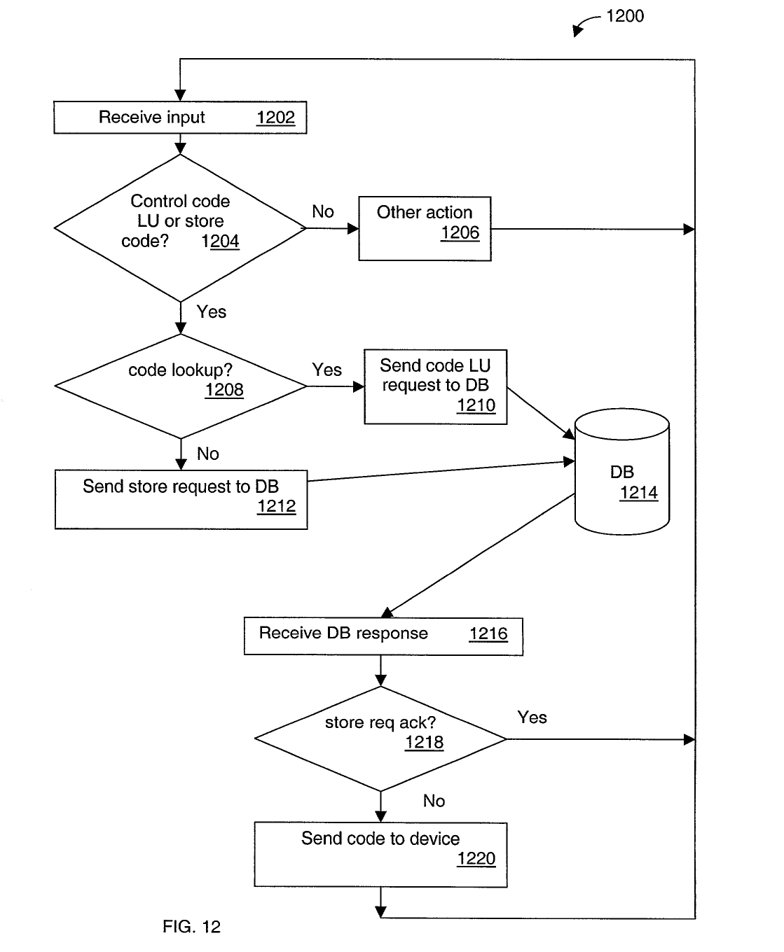

FIG. 12 illustrates one embodiment 1200 of storing and accessing control code information from a database. At 1202 an input is received. At 1204 the input received at 1202 is checked to determine if it is a control code lookup (LU) or a store code request. If it is neither then at 1206 another action may be taken and then back to 1202 to receive input. If at 1204 it is determined that the input received at 1202 is either a control code lookup request or a store code request, then at 1208 a check is made to see if it is a code lookup request. If so, then at 1210 a lookup request is sent to the database 1214. If the request is not a code lookup request then it is a store code request and at 1212 a store code request is sent to database 1214.

After database 1214 performs the requested operation a response from the database 1214 is received at 1216. At 1218, the database 1214 response received at 1216 is checked to see if it is a store code request acknowledgement (ack). If it is a store code request ack then back to 1202 to receive input. If at 1218 it is determined that the response received from the database is not a store request ack, then at 1220 the control code received from the database 1214 is sent to the device that requested it, and then back to 1202 to receive input.

Thus, a method and apparatus for control of advertisements have been described.

[image]

[image]

What is claimed is:

1. A method comprising:
receiving a communication;
receiving a control signal; and
operating on the communication based upon the control signal.

2. The method according to claim 1, wherein receiving the communication comprises receiving a video signal.

3. The method of claim 1 wherein the control signal is derived from the communication.

4. The method according to claim 1, wherein receiving the control signal comprises receiving the control signal via an Internet communication.

5. The method of claim 1 wherein the communication is an advertisement.

6. The method according to claim 5, wherein operating on the advertisement based upon the control signal further comprises muting the advertisement.

7. The method according to claim 6, wherein the muting further comprises a video or visual muting.

8. The method according to claim 7, wherein the muting further comprises an audio muting.

9. The method of claim 8 wherein receiving the control signal comprises receiving the control signal via an Internet communication.

10. A processing system comprising a processor, which when executing a set of instructions, performs the following:
receives an advertisement intended for a viewer;
receives a control signal related to the advertisement; and
operates on the advertisement based upon the control signal.

11. The system of claim 10, wherein the control signal is not received from the viewer.

12. An apparatus comprising:
a media receiver having an input and an output, the input coupled to receive a media transmission;
a control device, having an input and output, the input coupled to receive the media receiver output; and
a presentation device having an input and an output, the input coupled to receive the control device output, and the output presented for a user.

13. The apparatus of claim 12, further comprising a second input to the control device, the second input coupled to receive a communication.

14. The apparatus of claim 13, wherein the communication is received from a source selected from the group consisting of the Internet, a wireless link, a user, a telephone connection, the media transmission, a device playback of a previously defined user command, a real-time user initiated command, a database, a remote database, the control device, a remote control, a computer, a playback unit, an audio device, a video device, an audio/video device, a visual device, and an audiovisual device.

15. A machine-readable medium having stored thereon instructions, which when executed by a system, causes said system to perform the following:
receive a communication;
receive a control signal; and
operate on the communication based upon the control signal.

16. The machine-readable medium of claim 15 wherein the control signal is derived from the communication.

17. The machine-readable medium of claim 15 wherein the control signal is received from a source selected from the group consisting of the Internet, a wireless link, a user, a telephone connection, the communication, a device playback of a previously defined user command, a real-time user initiated command, a database, a remote database, a remote control, a computer, a playback unit, an audio device, a video device, an audio/video device, a visual device, and an audiovisual device.

18. An apparatus comprising:
means for receiving a communication;
means for receiving a control signal; and
means for operating on the communication based upon the control signal.

19. The apparatus of claim 18, wherein means for receiving the control signal is a means for deriving the control signal from the communication.

20. The apparatus claim 18 wherein means for receiving the control signal is a means for receiving the control signal from a source selected from the group consisting of the Internet, a wireless link, a user, a telephone connection, the communication, a device playback of a previously defined user command, a real-time user initiated command, a database, a remote database, a remote control, a computer, a playback unit, an audio device, a video device, an audio/video device, a visual device, and an audiovisual device.

21. A method comprising:
setting a user threshold level to receive data;
receiving an offer having compensation to present the data;
comparing the offer to the user threshold level and accepting or rejecting the offer based upon the comparison; and
if accepted:
presenting the data; and
transferring the compensation to a user selected destination.

22. The method of claim 21, wherein the data is sensory data selected from the group consisting of audio data, visual data, audiovisual data, smell data, tactile data, and taste data.

23. The method of claim 21, wherein the user threshold level is a user payment level, the data is an advertisement, the compensation is a payment, accepting the offer based upon the comparison is accepting the offer if the payment is not less than the user payment level, and the user selected destination is a user selected account.

24. The method of claim 23 wherein the payment is from a payor selected from the group consisting of an advertiser, a non-advertiser, a subscriber, a non-subscriber, a sponsor, a user, a non-user, and a third party.

25. The method of claim 21 wherein the user threshold level comprises options selected from the group consisting of payment, type of advertisement, time of day, user age, user income, user viewing preferences, a program rating, and predefined options.

26. The method of claim 21 wherein the compensation is selected from the group consisting of a credit, a discount, a free item, a voucher, a coupon, money, a certificate, a redemption certificate, a free play, a free view, an award, and points.

27. The method of claim 21 wherein the user selected destination is an account selected from the group consisting of a credit card account, a checking account, a savings account, a payment account, a billing account, an escrow account, a debt account, a debit account, an incentive account, a credit account, a tax account, a trust account, a charity account, an education account, a child support account, an automatic payment account, a premium services account, and a third party account

28. The method of claim 21 wherein transferring the compensation further comprises sending information to a database.

29. A machine-readable medium having stored thereon instructions, which when executed by a system, causes said system to perform the following:
retrieve a user preference;
receive a media stream;
extract from the media stream a segment;
retrieve from a database information related to the segment;
compare the segment information to the user preference; and
play the segment if the comparison meets the user preference.

30. The machine-readable medium of claim 29 further comprising transferring a payment.

31. The machine-readable medium of claim 30 wherein the payment is a transfer of money the transfer of money selected from the group consisting of a payment from the user, a payment to the user, a payment from a sponsor, a payment from an advertiser, and a payment from a third party.

32. The machine-readable medium of claim 29 wherein the database is a remote database.

33. The machine-readable medium of claim 29 wherein the segment is a program or an advertisement.

34. An apparatus comprising:
means for receiving a user input;
means for receiving a data stream containing an advertisement; and
means for operating on the data stream based on the user input.

35. The apparatus of claim 34, wherein means for operating on the data stream further comprises means for operating on the advertisement.

36. The apparatus of claim 35, wherein means for operating on the advertisement is a means for modifying a presentation of the advertisement.

37. The apparatus of claim 36, wherein the means for modifying a presentation of the advertisement further comprises a means for modifying an attribute of the advertisement selected from the group consisting of audio, visual, and audiovisual.

38. The apparatus of claim 35, wherein means for operating on the advertisement is a means for video muting.

39. A system comprising:
a processor; and
a memory coupled to the processor, the memory for storing instructions and data which configure the processor to:
retrieve a user preference;
receive a media stream;
extract from the media stream a segment;
retrieve from a database information related to the segment;
compare the segment information to the user preference; and
play the segment if the comparison meets the user preference.

40. The system of claim 39 further comprising transferring a payment.

41. The system of claim 40 wherein the payment is a transfer of money the transfer of money selected from the group consisting of a payment from the user, a payment to the user, a payment from a sponsor, a payment from an advertiser, and a payment from a third party.

42. An apparatus comprising:
means for retrieving a user preference;
means for receiving a media stream;
means for extracting from the media stream a segment;
means for retrieving from a database information related to the segment;
means for comparing the segment information to the user preference; and
means for playing the segment if the comparison meets the user preference.

43. The apparatus of claim 42 further comprising means for transferring a payment.

44. The apparatus of claim 43, wherein means for transferring a payment is a means for transferring money the transfer of money selected from the group consisting of a payment from the user, a payment to the user, a payment from a sponsor, a payment from an advertiser, and a payment from a third party.

45. A method comprising:
receiving a user request;
dispatching a query to a database;
receiving a command from the database; and
executing the command from the database.

46. The method according to claim 45, wherein the command from the database is a control command for controlling a device.

47. The method according to claim 46, wherein the control command is substantially the same as from a remote control for controlling the device.

48. The method according to claim 46, wherein the device is a presentation device having an output selected from the group consisting of an audio output, a visual output, and an audiovisual output.

49. The method according to claim 46, wherein the device is a presentation device having a control input, the control input selected from the group consisting of an infrared input, a wireless input, an Ethernet input, a cable input, an Internet input, a coaxial input, an audio input, a video input, a radio frequency input, a wired input, and an optical input.

50. An apparatus comprising:
a device having a media input, a media output, a control input, and a control output, the media input coupled to receive a media stream, the control input coupled to receive a control signal, and the control output to transmit a command; and
a presentation device having an input and an output, the input coupled to receive the device media output, and the output for presentation to a user.

51. The apparatus of claim 50, wherein the control signal originates from a source, the source selected from the group consisting of a hand held control, the device, an Internet communication, a database, and the media stream.

52. The apparatus of claim 50, wherein the command is substantially the same as that emanating from an activated hand held remote control.

53. A system comprising a processor, which when executing a set of instructions, performs the following:
receives an input media stream;
accesses a database for a command;
executes the command from the database; and
transmits an output media stream.

54. The system of claim 53, wherein executing the command from the database further comprises modifying the input media stream per the command from the database.

55. The system of claim 54, wherein the modified input media stream is the output media stream.

56. The system of claim 53, wherein executing the command from the database further comprises controlling a presentation device.

57. An apparatus comprising:
means for receiving an input media stream;
means for receiving a control input;
means for transmitting an output media stream; and
means for controlling a device.

58. The apparatus of claim 57, wherein the means for controlling a device is means for transmitting substantially the same control code as transmitted from a hand-held remote control.

59. The apparatus of claim 57, wherein the means for receiving the control input is means for communicating with a source, the source selected from the group consisting of a hand held control, the apparatus, an Internet communication, a database, and the input media stream.

60. A machine-readable medium having stored thereon instructions, which when executed by a system, causes the system to perform the following:
receive an input media stream;
access a database for a command;
execute the command from the database; and
transmit an output media stream.

61. The machine-readable medium of claim 60 further comprising a payment transaction.

62. The machine-readable medium of claim 61 wherein the payment is a transfer of money the transfer of money selected from the group consisting of a payment from a user, a payment to a user, a payment from a sponsor, a payment from an advertiser, and a payment from a third party.
